(19) United States
(12) Patent Application Publication
(10) Pub. No.: US 2026/0258832 A1
(43) Pub. Date: Sep. 3, 2026

(54) LOCKING HOOK

(71) Applicant: YOKE INDUSTRIAL CORP., Taichung City (TW)

(72) Inventor: WEI-CHIEH HUNG, Taichung City (TW)

(73) Assignee: YOKE INDUSTRIAL CORP., Taichung City (TW)

(21) Appl. No.: 19/066,180

(22) Filed: Feb. 28, 2025

(51) Int. Cl. F16B 45/02

(52) U.S. Cl. CPC F16B 45/028

(57) ABSTRACT

A locking hook includes a hook body including a hook portion and a pivot section. A latch and a switch component are pivotally connected to the pivot section. The middle of the latch has an abutting part. An end of the latch abuts against the hook portion. The switch component has two side arms and a connection arm connected between the two side arms, thereby forming a position limiting surface. The position limiting surface is located in a rotational path of the abutting part. When the latch starts to pivot, the position limiting surface blocks the latch through abutting against the abutting part. After the position limiting surface pivots away from a position in which the position limiting surface could block the abutting part, the latch could be released. Therefore, the latch freely pivots towards the pivot section to open an opening of the hook body.

### BACKGROUND OF THE INVENTION

### Technical Field

The present invention relates generally to a hanging apparatus, and more particularly to a locking hook with a raised strength and a raised security.

### Description of Related Art

A conventional locking hook is provided with a main hook pivotally connected to a latch. A free end of the latch abuts against a free end of the main hook. The latch could open the main hook after the latch pivots. An opening is formed between the free end of the main hook and the free end of the latch.

To avoid the latch of the locking hook being accidentally opened, an abutting portion is formed on the latch, a switch is pivotally connected to the locking hook, and an abutting portion is formed on the switch. The abutting portion of the latch and the abutting portion of the switch could confine a pivot of the latch through being in contact with the latch before the switch pivots. After the switch pivots, the latch could be released and could freely pivot. Therefore, the latch of the locking hook could be prevented from being accidentally opened.

However, a structure of the switch is not solid and is formed through a plurality of sheet metals being folded. Therefore, when the abutting portion of the switch blocks the abutting portion of the latch and the abutting portion of the latch applies a great force to the abutting portion of the switch, the abutting portion of the switch might be deformed and be opened, so that it could not be ensured that the latch of the locking hook would not be accidentally opened because of the great force applied to the latch of the locking hook and the conventional locking hook with the switch is not secure enough.

### BRIEF SUMMARY OF THE INVENTION

In view of the above, the primary objective of the present invention is to provide a locking hook with a strength raised through a switch component. Therefore, when a latch of the locking hook is applied with a great force, the latch of the locking hook would not be accidentally opened, so that the locking hook could be securely used.

The present invention provides a locking hook including a hook body, a latch, and a switch component. The hook body includes a hook portion, a pivot section, and a base, wherein the hook portion, the pivot section, and the base are connected to one another in order. The hook portion has a first free end. The pivot section has a first pivot part and a second pivot part. The middle of the latch has an abutting part. Two ends of the latch respectively have a latch pivot part and a second free end, wherein the latch pivot part is pivotally connected to the first pivot part, so that the latch pivots between a first position and a second position. When the latch is located in the first position, the second free end abuts against the first free end. The switch component is pivotally connected to the second pivot part and pivots between a third position and a fourth position. The switch component has two side arms and a connection arm connected between two ends of the two side arms. Two parts of the two side arms connected to the connection arm and the connection arm jointly form a position limiting surface. When the switch component is located in the third position, the position limiting surface is located in a path in which the abutting part pivots from the first position to the second position with the latch. Therefore, the latch abuts against the abutting part to block a pivot of the latch when the latch starts to pivot from the first position to the second position. When the switch component is located in the fourth position, the position limiting surface pivots away from a position in which the position limiting surface blocks the pivot of the latch.

With the aforementioned design, when the latch is applied with the force to pivot towards the pivot section and then the position limiting surface of a position limiting component is pressed by the abutting part of the latch, the two side arms of the position limiting component would not open through the connection arm being connected to the two side arms during the two side arms applied with the force, so that the position limiting component has a better strength and maintains a better supporting force to support the position limiting surface abutting against the abutting part and block the pivot of the latch. Therefore, when the latch is applied with the great force, it could be prevented that the latch is accidentally opened because of the position limiting component being damaged, so that the locking hook could be securely used.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the locking hook according to an embodiment of the present invention;

FIG. 2 is an exploded view of the locking hook according to the embodiment of the present invention;

FIG. 3 is a perspective view of the locking hook seen from another direction according to the embodiment of the present invention;

FIG. 4 is a side view of the locking hook according to the embodiment of the present invention;

FIG. 5 is a sectional view along the 5-5 line in FIG. 4;

FIG. 5A is an enlarged view of a marked region 5A in FIG. 5;

FIG. 6 is a top view of the locking hook according to the embodiment of the present invention;

FIG. 7 is a sectional view along the 7-7 line in FIG. 6;

FIG. 8 is a schematic view, showing that the switch component pivots from the third position to the fourth position in FIG. 7; and

FIG. 9 is a schematic view, showing that the latch pivots from the first position to the second position in FIG. 8.

### DETAILED DESCRIPTION OF THE INVENTION

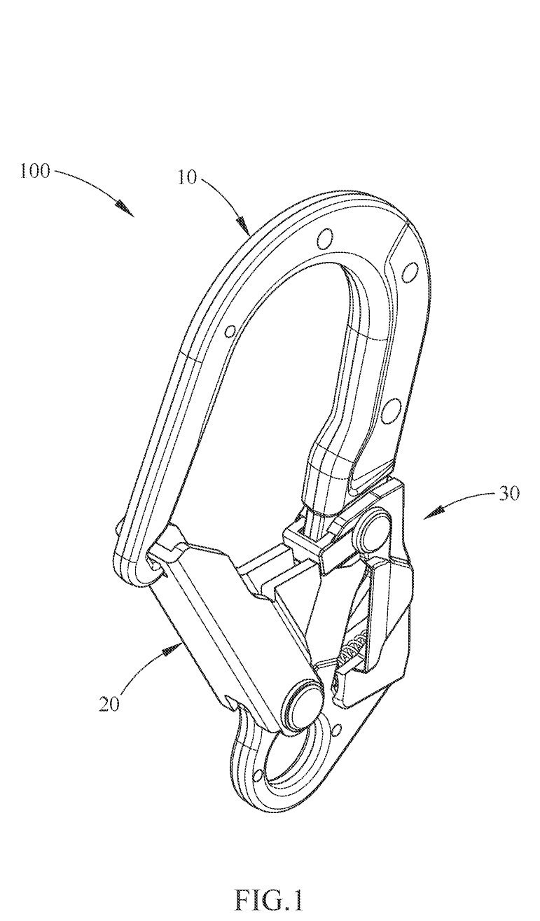

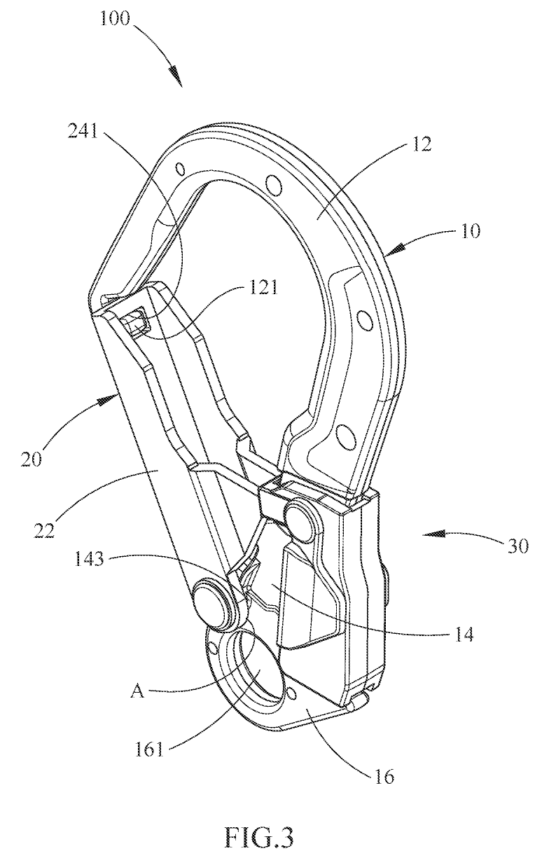

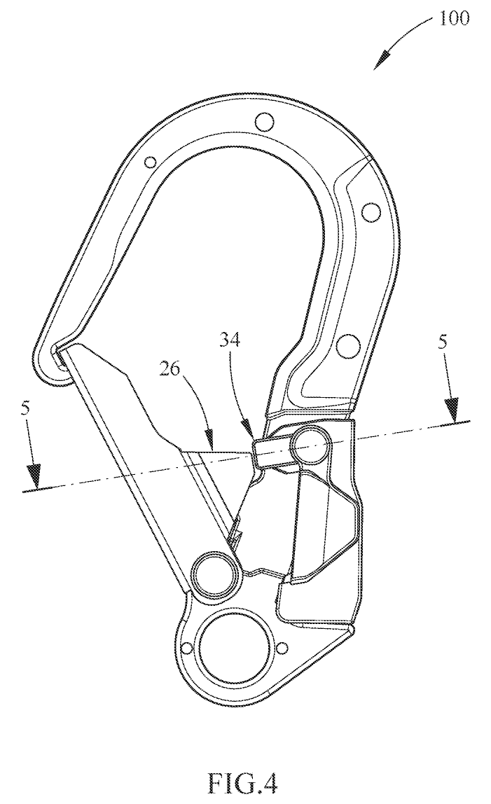

A locking hook 100 according to an embodiment of the present invention is illustrated in FIG. 1 to FIG. 5A and includes a hook body 10, a latch 20, and a switch component 30.

Referring to FIG. 1 to FIG. 3, the hook body 10 includes a hook portion 12, a pivot section 14, and a base 16, wherein the hook portion 12, the pivot section 14, and the base 16 are connected to one another in order. The hook portion 12 has an insulating outer layer and has a first free end 121. In the current embodiment, the first free end 121 is a bent hook. The pivot section 14 is a bar-shaped board. A part of the pivot section 14 adjacently connected to the base 16 has a first pivot part 141. A part of the pivot section 14 adjacently connected to the hook portion 12 has a second pivot part 142. In the current embodiment, the first pivot part 141 is an axle hole. A periphery of each of two ends of the first pivot part 141 forms a convex ring 143. The second pivot part 142 is an axle hole. The base 16 has a hanging ring hole 161. The base 16 and the part of the pivot section 14 adjacently connected to the base 16 has an insulating outer layer.

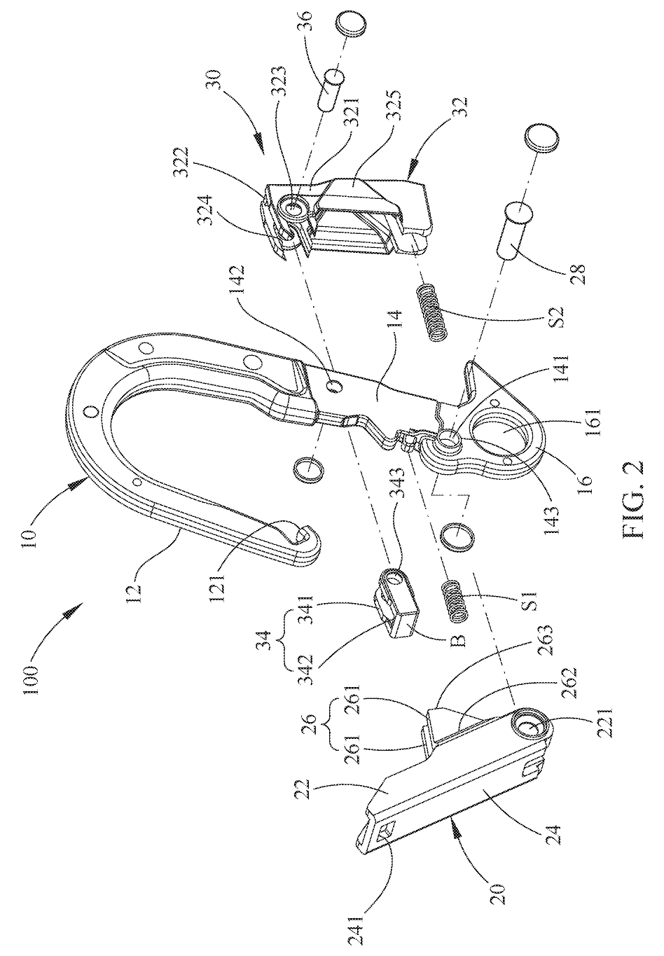

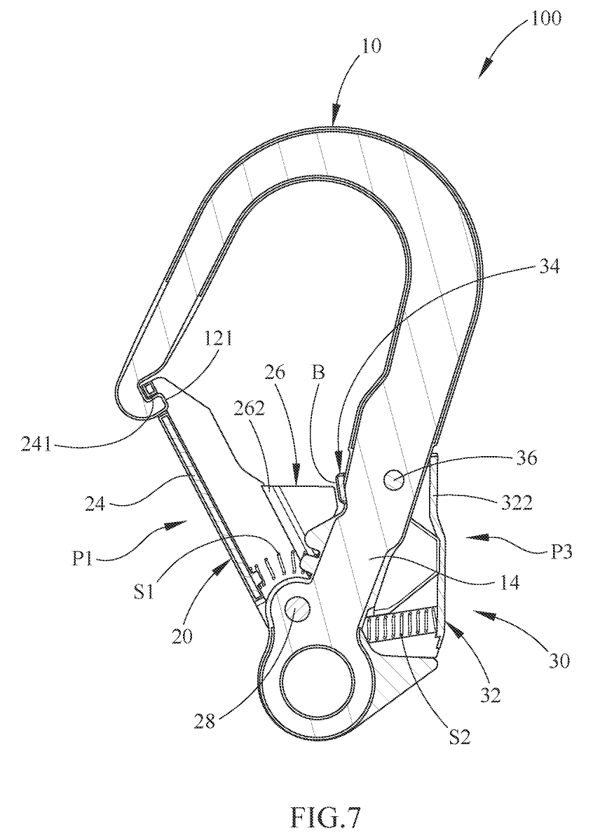

Referring to FIG. 2 to FIG. 5 and FIG. 7, the latch 20 has an insulating outer layer and includes two latch side boards 22, a latch bottom board 24, and an abutting part 26. Two ends of the two latch side boards 22 are located on two sides of the first pivot part 141. The two ends of the two latch side boards 22 form a latch pivot part 221. In the current embodiment, the latch pivot part 221 is an axle hole and faces the first pivot part 141. A latch pivot axle 28 passes through the first pivot part 141 and the latch pivot part 221, so that an end of the latch 20 is pivotally connected to the first pivot part 141. An end edge of each of the two convex rings 143 abuts against an inner surface of an end of each of the two latch side boards 22. A groove A is formed between an end of each of the two latch side boards 22 and a surface of the pivot section 14.

The latch bottom board 24 is connected between two sides of the two latch side boards 22 away from the switch component 30. An end of the latch bottom board 24 away from the latch pivot axle 28 has a second free end 241, wherein the second free end 241 is a hanging hole and is hung at the first free end 121 of the hook body 10. Overall, another end of the latch 20 abuts against the first free end 121 of the hook portion 12. The abutting part 26 includes two abutting boards 261, wherein the two abutting boards 261 are spaced. Each of the two abutting boards 261 is connected to another side of each of the two latch side boards 22 adjacent to the switch component 30. More specifically, each of two parts of the two abutting boards 261 adjacently connected to the two latch side boards 22 forms a bending section 262. Each of the two bending sections 262 is connected the middle of the another side of each of the two latch side boards 22 adjacent to the switch component 30. A side of each of the two abutting boards 261 adjacent to the switch component 30 forms an abutting surface 263.

Therefore, the latch bottom board 24 is disposed in the middle of the latch 20 and a minimum distance between the two abutting boards 261 is less than a minimum distance between the two latch side boards 22. A first restoring spring S1 is disposed between the hook body 10 and the latch 20 and abuts against the hook body 10 and the latch 20. More specifically, two ends of the first restoring spring S1 abut against the pivot section 14 and the latch bottom board 24 and are located between the pivot section 14 and the latch bottom board 24. Because the first restoring spring S1 applies a force to the latch 20, the second free end 241 of the latch 20 could keep abutting against the first free end 121 of the hook body 10 during the locking hook 100 statically placed.

Referring to FIG. 2 and FIG. 5 to FIG. 7, the switch component 30 incudes a pressing handle 32 and a position limiting component 34 connected to the pressing handle 32. In the current embodiment, the pressing handle 32 is plastic, e.g., engineering plastic. The pressing handle 32 includes two pressing handle side boards 321 and a pressing handle bottom board 322, wherein the two pressing handle side boards 321 are disposed on two sides of the pivot section 14. Two ends of the two pressing handle side boards 321 form a switch component pivot part 323, wherein the switch component pivot part 323 is an axle hole and faces the second pivot part 142. The two pressing handle side boards 321 have two slots 324 which are symmetrical. An end of each of the two slots 324 is a free end extending towards the latch 20. Another end of each of the two slots 324 communicates with the switch component pivot part 323. A bulge 325 is formed in the middle of each of the two pressing handle side boards 321. A space in the two bulge 325 allows the two abutting boards 261 of the latch 20 to be moved in the space in the two bulge 325. The pressing handle bottom board 322 is connected between two sides of the two pressing handle side boards 321 away from the pivot section 14. The pressing handle bottom board 322 is located out of the pivot section 14. An end of the pressing handle bottom board 322 corresponding to the switch component pivot part 323 abuts against an outer side of the pivot section 14, thereby confining an extent of the pressing handle 32 pivoting around the switch component pivot part 323 in a direction away from the pivot section 14.

In the current embodiment, the position limiting component 34 is a metal member with an insulating outer layer. The position limiting component 34 includes two side arms 341 and a connection arm 342, wherein the two side arms 341 of the position limiting component 34 are inserted into the two slots 324 of the pressing handle 32. The connection arm 342 is connected between two ends of the two side arms 341 and is located between the latch 20 and the pivot section 14. Two parts of the two side arms 341 connected to the connection arm 342 and the connection arm 342 jointly form a position limiting surface B. Another end of each of the two side arms 341 has a side arm axle hole 343, wherein the two side arm axle holes 343 face the switch component pivot part 323 and the second pivot part 142. A switch component pivot axle 36 passes through the second pivot part 142, the switch component pivot part 323, and the two side arm axle holes 343, so that the two side arms 341 of the position limiting component 34 are combined with the two pressing handle side boards 321 and the switch component 30 is pivotally connected to the second pivot part 142 of the hook body 10. When the switch component 30 pivots around the switch component pivot part 323 and the switch component pivot axle 36, the position limiting component 34 also pivots with the switch component 30 pivoting.

In the current embodiment, the position limiting surface B faces the two abutting surfaces 263 of the abutting part 26. A gap C is formed between the position limiting surface B and the two abutting surfaces 263. When the switch component 30 pivots around the switch component pivot part 323 and the switch component pivot axle 36 towards the pivot section 14, the position limiting surface B would not interfere with the two abutting surfaces 263 through the gap C, thereby avoiding that the two abutting surfaces 263 of the abutting part 26 confine a pivot of the switch component 30. A second restoring spring S2 which is compressed is disposed between the hook body 10 and the switch component 30 and abuts against the hook body 10 and the switch component 30. More specifically, two ends of the second restoring spring S2 are located between the pivot section 14 and the pressing handle bottom board 322 and abut against the pivot section 14 and the pressing handle bottom board 322. The second restoring spring S2 applies a force to the switch component 30. Therefore, once the switch component 30 is pressed to pivot towards the pivot section 14 and then is released, the switch component 30 would return to an original position because of the force applied by the second restoring spring S2.

In addition, a normal line of the position limiting surface B passes through a part of the switch component 30 pivotally connected to the second pivot part 142. For example, the normal line of the position limiting surface B passes through the switch component pivot axle 36. Therefore, when the latch 20 is applied with a force and would pivot towards the pivot section 14, the two abutting surface 263 abuts against the position limiting surface B of the switch component 30 during the latch 20 starting to pivot. However, because a direction of a force which the two abutting surface 263 applies to the position limiting surface B passes through a rotation center which the switch component 30 pivots around, the switch component 30 does not pivot and the position limiting surface B stays in a fixed position. Therefore, the position limiting surface B of the switch component 30 could block and confine a pivot of the latch 20.

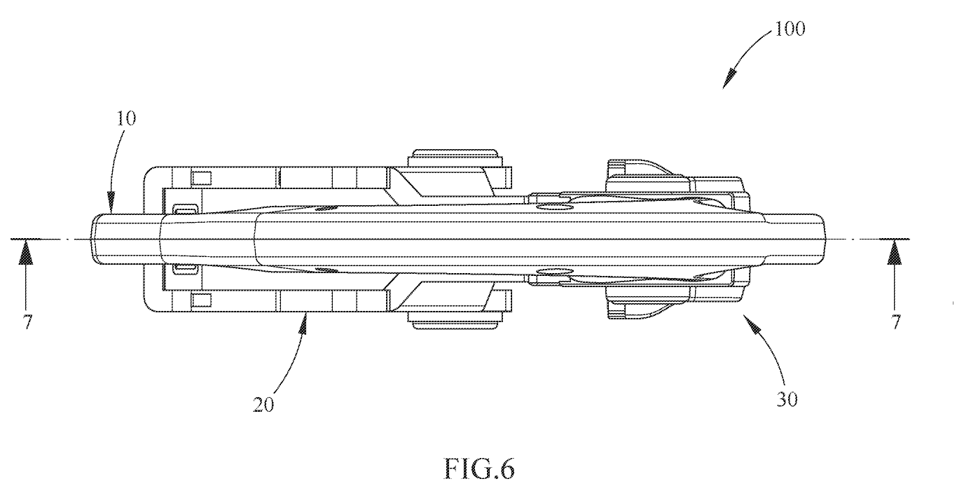

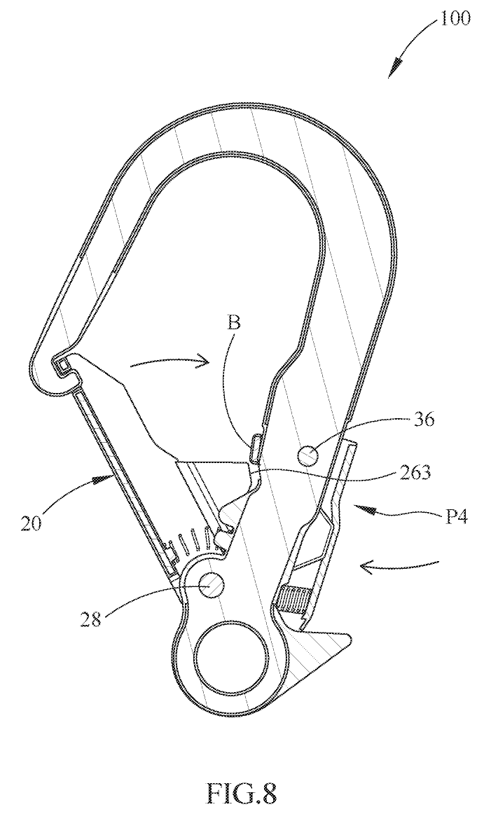

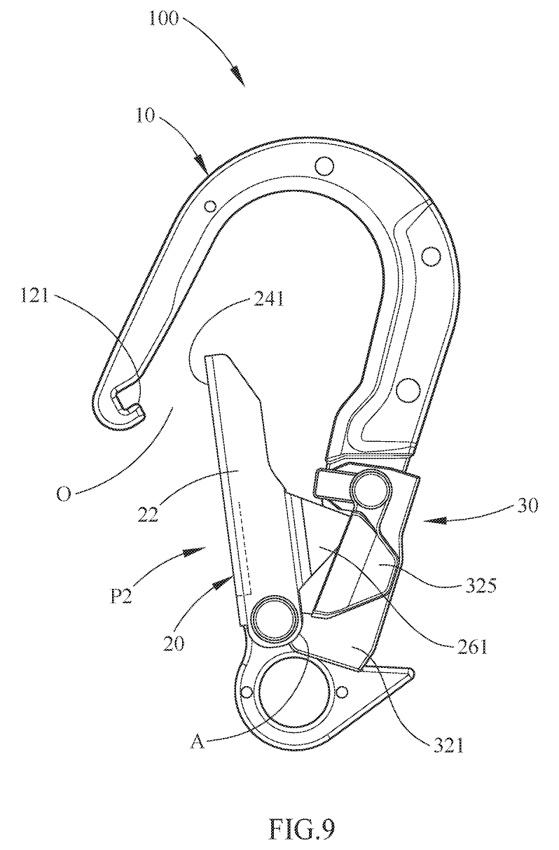

Referring to FIG. 6 to FIG. 9, during the locking hook 100 of the present invention is operated, if the pivot of the latch 20 is not confined by the switch component 30, the latch 20 could pivot around the latch pivot axle 28 between a first position P1 and a second position P2. When the locking hook 100 is statically placed, the latch 20 is located in the first position P1 and the second free end 241 abuts against the first free end 121 of the hook body 10. After the latch 20 pivots from the first position P1 to the second position P2, an opening O is formed between the first free end 121 of the hook body 10 and the latch 20.

When the latch 20 is located in the first position P1, the switch component 30 could pivot around the switch component pivot axle 36 between a third position P3 and a fourth position P4. When the locking hook 100 is statically placed, the switch component 30 is located in the third position P3. After the switch component 30 pivots from the third position P3 to the fourth position P4, the position limiting surface B pivoting with the switch component 30 would pivot away from a position in which the position limiting surface B faces the two abutting surfaces 263 of the abutting part 26 and would not block the pivot of the latch 20 from the first position P1 to the second position P2. When the switch component 30 pivots from the third position P3 to the fourth position P4, another end of each of the two pressing handle side boards 321 of the switch component 30 enters each of the two grooves A, thereby avoiding that the two pressing handle side boards 321 interfere with the two latch side boards 22 and then the pivot of the switch component 30 is confined.

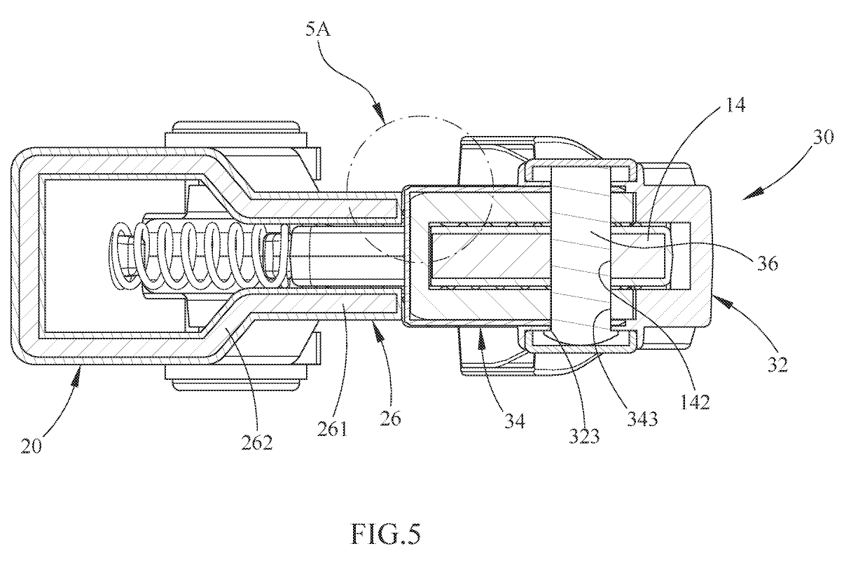

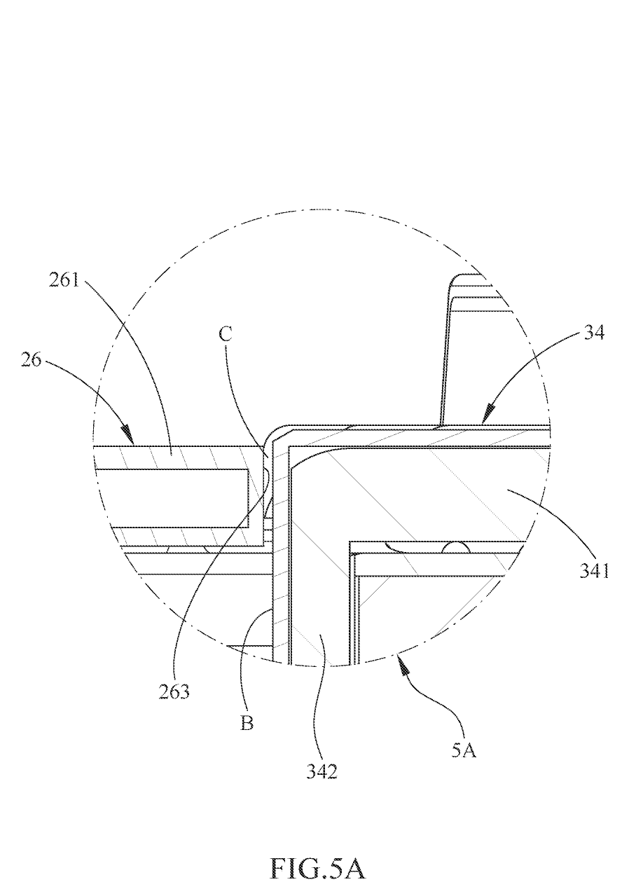

Referring to FIG. 1, FIG. 5, and FIG. 5A, when the position limiting surface B of the position limiting component 34 is pressed by the abutting part 26 of the latch 20, the two side arms 341 could stay opposite to each other without moving away from each other through the connection arm 342 connected to the two side arms 341 and maintain a great supporting force to abut against the abutting part 26 of the latch 20, so that the two side arms 341 are difficult to be damaged and would not move away from each other. Therefore, when the position limiting component 34 blocks the pivot of the latch 20, a structure of the position limiting component 34 is strong and could prevent the latch 20 from being accidentally opened, so that the locking hook 100 could be securely used.

Except for the plastic pressing handle 32 which the switch component 30 is provided with, the pressing handle 32 could be made of metal. Because the two side arms 341 are connected to two sides of the connection arm 342, an overall structural strength of the position limiting component 34 with the position limiting surface B is raised. Therefore, even if the position limiting component 34 is made of plastic (e.g., engineering plastic) except metal, the position limiting component 34 has a better strength than a structure of a conventional position limiting component. In other embodiments, the switch component 30 could be a structure integrated with the pressing handle 32 and the position limiting component 34 except for the switch component 30 of the embodiment including the pressing handle 32 and the position limiting component 34.

It must be pointed out that the embodiments described above are only some preferred embodiments of the present invention. All equivalent structures which employ the concepts disclosed in this specification and the appended claims should fall within the scope of the present invention.

What is claimed is:

1. A locking hook, comprising:
a hook body comprising a hook portion, a pivot section, and a base, wherein the hook portion, the pivot section, and the base are connected to one another in order; the hook portion has a first free end; the pivot section has a first pivot part and a second pivot part;
a latch of which the middle has an abutting part; two ends of the latch respectively have a latch pivot part and a second free end, wherein the latch pivot part is pivotally connected to the first pivot part, so that the latch pivots between a first position and a second position; when the latch is located in the first position, the second free end abuts against the first free end; and
a switch component pivotally connected to the second pivot part and pivoting between a third position and a fourth position; the switch component has two side arms and a connection arm connected between two ends of the two side arms; two parts of the two side arms connected to the connection arm and the connection arm jointly form a position limiting surface; when the switch component is located in the third position, the position limiting surface is located in a path in which the abutting part pivots from the first position to the second position with the latch. Therefore, the latch abuts against the abutting part to block a pivot of the latch when the latch starts to pivot from the first position to the second position; when the switch component is located in the fourth position, the position limiting surface pivots away from a position in which the position limiting surface blocks the pivot of the latch.

2. The locking hook as claimed in claim 1, wherein the switch component comprises a pressing handle and a position limiting component connected to the pressing handle; the pressing handle has a switch component pivot part, wherein the switch component pivot part is pivotally connected to the second pivot part, so that the switch component pivots between the third position and the fourth position; the position limiting component comprises the connection arm and the two side arms; another end of each of the two side arms is combined with the pressing handle.

3. The locking hook as claimed in claim 2, wherein two sides of the pressing handle have two pressing handle side boards; the two pressing handle side boards are disposed on two sides of the pivot section; two ends of the two pressing handle side boards form the switch component pivot part; a pressing handle bottom board is connected between two sides of the two pressing handle side boards away from the pivot section; the two side arms of the position limiting component are combined with the two pressing handle side boards; the connection arm of the position limiting component is located between the latch and the pivot section.

4. The locking hook as claimed in claim 3, wherein the second pivot part is an axle hole; the switch component pivot part is an axle hole and passes through an end of each of the two pressing handle side boards; a switch component pivot axle passes through the second pivot part and the switch component pivot part.

5. The locking hook as claimed in claim 4, wherein the another end of each of the two side arms has a side arm axle hole; the two side arm axle holes fit around the switch component pivot axle.

6. The locking hook as claimed in claim 5, wherein the two pressing handle side boards have two slots which are symmetrical; an end of each of the two slots is a free end; another end of each of the two slots communicates with the switch component pivot part; the two side arms of the position limiting component are inserted into the two slots.

7. The locking hook as claimed in claim 3, wherein the second pivot part is an axle hole; the switch component pivot part is an axle hole and passes through an end of each of the two pressing handle side boards; the two pressing handle side boards have two slots which are symmetrical; an end of each of the two slots is a free end; another end of each of the two slots communicates with the switch component pivot part; the two side arms of the position limiting component are inserted into the two slots; the another end of each of the two side arms has a side arm axle hole; a switch component pivot axle passes through the second pivot part, the switch component pivot part, and the two side arm axle holes.

8. The locking hook as claimed in claim 3, wherein the first pivot part is an axle hole; two sides of the latch have two latch side boards; two ends of the two latch side boards are located on two sides of the first pivot part; a latch bottom board is connected between two sides of the two latch side boards away from the switch component; two ends of the two latch side boards form the latch pivot part; the latch pivot part is an axle hole; a latch pivot axle passes through the first pivot part and the latch pivot part.

9. The locking hook as claimed in claim 8, wherein the abutting part comprises two abutting boards; the two abutting boards are spaced; each of the two abutting boards is connected to another side of each of the two latch side boards adjacent to the switch component.

10. The locking hook as claimed in claim 9, wherein each of two parts of the two abutting boards adjacently connected to the two latch side boards forms a bending section; each of the two bending sections is connected to the another side of each of the two latch side boards adjacent to the switch component; a minimum distance between the two abutting boards is less than a minimum distance between the two latch side boards; a periphery of each of two ends of the first pivot part forms a convex ring; an end edge of each of the two convex rings abuts against an inner surface of an end of each of the two latch side boards; a groove is formed between an end of each of the two latch side boards and a surface of the pivot section; when the switch component pivots from the third position to the fourth position, a part of the switch component enters the two grooves.
